(19) United States
(12) Patent Application Publication
(10) Pub. No.: US 2024/0425088 A1
(43) Pub. Date: Dec. 26, 2024

(54) VEHICLE SYSTEM AND METHOD

(71) Applicant: Transportation IP Holdings, LLC, Norwalk, CT (US)

(72) Inventors: Aaron Nye, Norwalk, CT (US); Milan Karunaratne, Norwalk, CT (US); Adam Franco, Norwalk, CT (US); Ankit Mathur, Norwalk, CT (US); Andrew Jackson Guntrum, IV, Pittsburgh, PA (US); James David LeJeune, Pittsburgh, PA (US); Troy Edward Tancraitor, Pittsburgh, PA (US); Quentin Johann Torgerson, Pittsburgh, PA (US)

(73) Assignee: Transportation IP Holdings, LLC, Norwalk, CT (US)

(21) Appl. No.: 18/753,890

(22) Filed: Jun. 25, 2024

Related U.S. Application Data
(63) Continuation-in-part of application No. 18/456,220, filed on Aug. 25, 2023.

(30) Foreign Application Priority Data
Jun. 26, 2023 (EP) 23181485.6

(51) Int. Cl. B61B 13/12

(52) U.S. Cl. CPC B61B 13/12

(57) ABSTRACT

A vehicle and method of operating the vehicle that is operationally non-disruptive to one or more other rail vehicles or equipment of a railroad. The vehicle including a frame, drive wheels, and articulatable arms. The articulatable arms extend from the frame and supporting the drive wheels. The articulatable arms are selectively transitionable between first orientations and second orientations, and the drive wheels are engageable with rails that are configured to support the rail vehicle having wheel pairs. In the first orientations the drive wheels engage with the rails to support the frame, and in the second orientations the drive wheels disengage from the rails.

### CROSS-REFERENCE TO RELATED APPLICATIONS

This application is a non-provisional patent application claiming priority to, European Patent Application No. 23181485.6, which was filed on Jun. 26, 2023, and to U.S. patent application Ser. No. 18/456,220, which was filed on Aug. 25, 2023, the entire disclosures of which are hereby incorporated by reference herein.

### BACKGROUND

### Technical Field

The subject matter described herein relates to a vehicle and a method for moving the vehicle along a route.

### Discussion of Art

Within a railroad switching yard there are many operational tasks that must be completed on a regular basis-some of these tasks are complex (e.g., repair work on damaged railcar components, maintenance of track switches, etc.) while others are relatively simple (e.g., inspecting air brakes, pulling pins, throwing switches, locating railcars, etc.). Various vehicles and equipment may interfere with the movement or activities of other vehicles and equipment. It may be desirable to have a vehicle that is less operationally disruptive and differs from those that are currently available.

### BRIEF DESCRIPTION

In one or more embodiments, a vehicle for use on a railway, the railway having a pair of rails, each of the pair of rails having a resting surface for a wheel of a railcar, the vehicle comprising a frame and a plurality of articulatable arms extending from the frame. Each articulatable arm comprising a first joint portion attached to the frame a second joint portion rotatably attached to the first joint portion about an articulation axis, a flanged wheel rotatably attached to the second joint portion such that the flanged wheel is rotatable relative to the second joint portion about a rotation axis, a drive motor configured to rotate the flanged wheel about the rotation axis, and an actuator configured to rotate the second joint portion and the flanged wheel relative to the first joint portion about the articulation axis to transition the articulatable arm between a first configuration where the flanged wheel is engaged with and rests upon the resting surface of one of the rails and a second configuration where the flanged wheel is disengaged from the rails. Each articulatable arm, or pairs of arms, of the plurality of articulatable arms is selectively actuatable between the first configuration and the second configuration.

In one or more embodiments, a vehicle comprising a frame, drive wheels, articulatable arms, and a control circuit. The articulatable arms extend from the frame and supporting the drive wheels. The articulatable arms are selectively transitionable between first orientations and second orientations, and the drive wheels are engageable with rails that are configured to support a rail vehicle having wheel pairs. In the first orientations the drive wheels engage with the rails to support the frame, and in the second orientations the drive wheels disengage from the rails. The control circuit is configured to receive sensor input indicative of detecting at least one wheel of the wheel pairs on at least one of the rails. The control circuit is configured to selectively transition the articulatable arms between the first orientations and the second orientations to avoid contact with the wheel pairs of the rail vehicle while maintaining the frame within a region between the rails.

In one or more embodiments, a method comprising detecting a wheel of a transport vehicle that is on a rail being a determined distance from a drive wheel of a second vehicle, and actuating a support structure of the drive wheel to swing the support structure and drive wheel from a first position to a second position, and the drive wheel in the second position avoids contacting the wheel of the transport vehicle while both traversing the transport vehicle and the second vehicle by each other and maintaining the second vehicle adjacent to the rail.

### BRIEF DESCRIPTION OF THE DRAWINGS

Reference is made to the accompanying drawings in which similar components are indicated using the same reference numbers, and in which:

FIG. 1 illustrates a system in accordance with at least one aspect of the disclosure.

FIG. 2 illustrates a support structure, in accordance with at least one aspect of the disclosure.

FIG. 3 illustrates the support roller in a first position.

FIG. 4 illustrates an embodiment of the support roller in a second position.

FIG. 5 is a perspective view of a vehicle according to an embodiment of the invention.

FIG. 6 is a perspective view of a vehicle according to an embodiment of the invention.

FIG. 7 is a side view of the vehicle of FIG. 6.

FIG. 8 is a perspective view of one of a portion of the frame and one of the articulatable arms of the vehicle of FIG. 6.

FIG. 9 is a plan view of one of the articulatable arms of the vehicle of FIG. 6.

FIG. 10 is a plan view of one of the articulatable arms of the vehicle of FIG. 6.

FIG. 11 is a plan view of one of the articulatable arms of the vehicle of FIG. 6.

FIG. 12 is a plan view of the vehicle of FIG. 6.

FIG. 13 is a plan view of the vehicle of FIG. 6.

FIG. 14 is a perspective view of a portion of the vehicle of FIG. 6.

FIG. 15 is a side view of the vehicle of FIG. 14.

FIG. 16 is a plan view of FIG. 15.

FIG. 17 is a plan view of FIG. 15.

FIG. 18 is a plan view of FIG. 15.

FIG. 19 is a plan view of FIG. 15.

FIG. 20 is a schematic of a control circuit for an embodiment of a vehicle disclosed herein.

FIG. 21 is a perspective view of a vehicle according to an embodiment of the invention.

FIG. 22 is a perspective view of one of the actuatable arms of the vehicle of FIG. 21.

FIG. 23 is a front view of the actuatable arm of FIG. 22.

FIG. 24 is a plan view of the actuatable arm of FIG. 23.

FIG. 25 is a front view of the actuatable arm of FIG. 22.

FIG. 26 is a plan view of the actuatable arm of FIG. 25.

FIG. 27 is a front view of the actuatable arm of FIG. 22.

FIG. 28 is a plan view of the actuatable arm of FIG. 27.

FIG. 29 is a perspective view of the vehicle of FIG. 21.

FIG. 30 is a perspective view of the vehicle of FIG. 21.

### DETAILED DESCRIPTION

The subject matter described herein relates to a vehicle and a method for moving the vehicle along a route. During operation, the vehicle may interact with other transport vehicles, such as a railcar, on the route by moving past them while re-positioning its support structures. In one embodiment, the vehicle may approach a transport vehicle and retract, pivot, swivel, swing, or otherwise reposition its wheels or support structures to avoid contact while still allowing the vehicle to progress along the route or track. In one embodiment, as the vehicles traverse relative to each other, no portion of the system touches or engages any portion of the train/car/wagon. In particular, the wheels of the two vehicles do not collide when moving past or across each other.

In one embodiment, the vehicle is a system that has a frame with a longitudinal axis and, on each of two opposite sides of the longitudinal axis, a plurality of support structures. The support structures each include a support element that can engage an upper surface of a route. In the illustrated embodiment, the route is a pair of rails that form a rail track. The support element may include a connection element connecting the support element to the frame, the connection element may allow the support element to move from a first position to a second position. The movement may be characterized relative to the frame. In various embodiments, the first position may be an operative position, an extended position, a supported position, an on-rail position, and/or an engaged position; and, the second position may be an inoperative position, a retracted position, a pivot position, a swung position, a swivel position, an unsupported position, an off-rail position, and/or a disengaged position.

The connection element may include or be coupled with an actuating element. The actuating element may actuate the support element from the first position to the second position and/or from the second position to the first position. At least part of each support element of each support structure on one of the sides of the longitudinal axis extending, when in the first position and when the system is projected onto a horizontal plane, farther than a determined distance from the longitudinal axis, at least part of each support element of each support structure on the other of the sides of the longitudinal axis, the other side being opposite to the first side, extending, when in the first position and when the system is projected onto the horizontal plane, farther than the determined distance from the longitudinal axis, no part of the support elements extends, when in the second position and when the system is projected onto the horizontal plane, farther than the determined distance from the longitudinal axis. That is, the support structures may pivot forwards and/or backwards to avoid collision with the wheels of the rail vehicles. In other embodiments, the support structures may retract towards the center between the tracks or may pivot upwards out of the horizontal plane.

The frame may have a longitudinal axis which normally would be a center axis of the frame. The longitudinal axis normally would be parallel to the rails or track and may be a center line between the rails.

A railway track may have two rails that are at least substantially parallel and have the same distance between them, seen in a direction perpendicular to the direction of either rail. Each rail having a top portion, a foot portion, and a web intermediate the top portion and the foot portion. In various embodiments, the top portion of the rail may be a running surface, or a resting surface, for a wheel of a train or railcar. A plurality of support structures is provided on either side of the longitudinal axis and thus engage each of the two rails along a plurality of positions thereof. This has the advantage that as a train wheel is passing, or as the system moves past a train wheel, the train wheel may require one or more of the support structures to not engage the rail, while others remain in engagement, so that the frame is supported by the rails even when train wheels pass. In one embodiment, the support structures engage the top portion, or resting surface, of the rail of the railway. In an alternative embodiment, the support structures engage the foot portion of the rail of the railway.

The support elements engaging one rail engage this rail at a plurality of known positions along the rail. These positions may be equidistant and determined based on the dimensions of train/wagon/car wheels and/or the distance between these on the train/car/wagon, such as on a bogie thereof.

Each support structure may include a support element that can engage an upper surface of a railway rail. This upper surface is the same surface by which the train wheels are supported when the train sits on or moves along the track.

In order for the frame to be supported by the support elements, a connection element is provided for each support structure for connecting the support element to the frame. Because the train wheels are also supported by the upper surface of the railway rail, the connection element allows the support element to move, relative to the frame, from a first position to a second position to retract, pivot, swivel, swing, or otherwise reposition the support structures to avoid contact with the train wheels while still allowing the vehicle to progress along the route or track or allowing the vehicle to remain stationary as the train wheels pass by.

In the first position, at least part of the support element extends, when projected onto a horizontal plane, farther than a determined distance from the longitudinal axis. The determined distance may be a distance from the longitudinal axis and to an inner edge of the upper surface of the rail, an inner surface of the head of the rail or an inner surface of the train/wagon/car wheel or the radially outermost portions thereof. When in the first position, the support element extends to above the upper surface of the rail so that it may engage it such as being supported thereon.

In the second position, no part of the support element extends, when projected onto the horizontal plane, farther than the determined distance from the longitudinal axis. Thus, the train/car/wagon wheel may pass this position of the system without engaging the support element. Or, if the system is in motion, this position of the system may pass the train/car/wagon wheel without the support element engaging the wheel. As described further below, the second position may be a position where the support element is positioned so that it does not engage a train wheel when passing on the pertaining rail. The second position may be positioned vertically as well as horizontally away from the first position.

The connection element may include an actuating element for actuating the support element from the first position to the second position and/or from the second position to the first position. The actuating element may include any type of actuator, such as a hydraulic actuator, gas pressure actuator, electrical or combustion motor/engine, or a passive actuator, such as a spring or other resilient element biasing the support element toward one of the first or second position. An actuator element may be one that can engage with the rail or a wheel of a train/wagon/car to derive force or torque therefrom for providing the actuating operation.

At least part of each support element of each support structure on one of the sides of the longitudinal axis extend, when in the first position and when the system is projected onto a horizontal plane, farther than a determined distance from the longitudinal axis. In this manner, all support elements, when in the first position, may be supported on the pertaining rail. As long as one or more support elements are supported on the rail, others may be in the second position.

The same is the situation for the support elements engaging the other rail of the track. At least part of each support element of each support structure on the other of the sides of the longitudinal axis, the other side being opposite to the first side, extending, when in the first position and when the system is projected onto the horizontal plane, farther than the determined distance from the longitudinal axis.

In one embodiment, no part of the support elements may extend, when in the second position and when the system is projected onto the horizontal plane, farther than the determined distance from the longitudinal axis. It may be desirable to keep the part of the frame from extending farther away from the axis than the determined distance. Thus, the frame, when projected onto the plane, may be disposed entirely between the rails. In this manner, no part of the frame may be engaged by any train/wagon/car wheels passing or passed by the frame on the rails.

If the longitudinal axis is not defined at the center between the rails, the above determined distance may not be the same on the two sides of the axis. Then, two determined distances would be used, but this does not alter the function of the support elements nor the first and second positions.

During one portion of the operation, at least one set or more of the support elements may be supporting the frame between the rails and not touching the ground, the ties, or sleepers between the rails. In another operational mode, such as the traversal of a crossing where the road is higher than the sleepers or ties, the vehicle may bottom out such that additional sets of wheels or skids support the vehicle weight through the crossing. The propulsion may be provided in one of several ways, such as a drive element for wheels on the underbelly of the vehicle, or by moving the support elements to a third position, such as tilted downward towards the rails to obtain traction or tilted upward away from the rails to raise the frame of the vehicle above an obstruction. In one embodiment, the connection element may be attached to the frame such that it is pivotable relative to the frame about an axis that is parallel to the ground. In such instances, the actuation of the connection element can raise and/or lower the frame relative to the rails. In one embodiment, a linear actuator may be positioned between the connection element and the frame to raise and/or lower the connection element and the support element relative to the frame.

In one embodiment, the system may include a drive for moving the system along the rails. In this situation, the system may move along the rails and perform a desired function. Suitable payloads and functions may include storage for moving goods below the train, an inspection package containing one or more sensors (e.g., to sense the undercarriage of a rail vehicle, or the condition of the track/tie/ballast/switch), robotic arms for performing tasks (such as, e.g., lacing brake hoses), power provisioning to charge other devices, tools to clean or clear aspects of tracks or switches (e.g., clearing rocks from a stuck switch), cleaners for removing debris or contamination (e.g., from the track surface), abrasives or grit to facilitate tractive effort for another vehicle, safety equipment (e.g., fire suppression materials), communication relay or extender equipment, warning notices, GPS and location devices, positive vehicle control devices, and the like. Further, the system may provide visual point inspection of the rails of the railway and/or vehicles positioned on, or adjacent to, the railway. The system may provide railway track mapping and/or location auditing. Further, the system may provide rolling stock inventory counting and/or location verification of rolling stock. In one embodiment, the system may inspect and/or gather data on tracks (including ties, spikes, anchors), ballast, foliage, and wayside terrain. With regard to the terrain, the data collection can include moisture content (including water level), soil compaction level, grade (overall and the rail level relative to each other), the presence or absence of fallen rocks, degree of washout, and the like. Another item to monitor may include leaf and bug coverage of the rail surface, and another may include the state of infrastructure for transportation (or otherwise), with an example being aspects of a bridge by which the rail tracks are supported.

In one embodiment, the support elements are support rollers or tracks, and there is a drive element connected to at least two of the support rollers/tracks so as to rotate or otherwise power these. The drive element may engage the wheels, which in turn engage the rails and move the system along the rails. The system may include a power source. Suitable power sources may include one or more of a combustion engine, a fuel cell, a solar cell, a battery, and the like. A suitable control circuit may actuate the drive, which may be done via remote control, via a tether, or by autonomous function.

In one embodiment, at least one connection element may include a first portion fixed in relation to the frame, and a second portion including the support element. The second portion may be movable in relation to the first portion to bring the support element from the first position to the second position. The actuating element may be used to switch positional modes of the portions. The first portion may be coupled to and part of the frame. This first portion may be positioned no farther from the axis than the determined distance so that the first portion is positioned, in the projection onto the plane, between the rails.

When the support element is a support roller or track, this roller/track may be rotatably provided in relation to a remainder of the second portion. The actuating element may be embodied in a number of manners. The actuating element may be completely or partly mechanical and may require no external power source. Alternatively, the actuating element may require power to actuate the support element in one direction between the first and second positions or in both directions.

The movement from the first to the second position may be selected with reference to the design of the frame. The support element may translate horizontally toward the axis to move to the second position. Alternatively, or additionally, the support element may be rotated around an axis, such as an axis which is closer to the frame than the determined distance. The rotation may be around a rotational axis, such as a horizontal axis or a vertical axis. It may be desired that the support element, and sometimes all of the system, does not interfere with a passing wheel or with any portion of a passing train/wagon/car. When the support element is in the second position, it is desired that no part of the pertaining support structure is positioned farther from the axis than the determined distance.

Situations may exist where the support element is attached to a pushing element, which may engage the passing wheel and acts to position the support element in the second position. In other situations, the movement of the support element takes place using other components where it may then be desired that no part of the system touches any part of the train/car/wagon.

In one embodiment, the actuating element may include a pushing element fixed in relation to the second portion, wherein, when projected onto the plane: at least part of the actuating element extends farther than the determined distance from the longitudinal axis, when the pertaining support element is in the first position, and no part of the actuating element extends farther than the determined distance from the longitudinal axis, when the support element is in the second position.

This pushing element may be that can engage an approaching wheel of a train/car/wagon and use a relative velocity between the frame (or first portion of the pertaining support structure) and the wheel to displace in relation to the first portion and thereby cause actuation of the pertaining support element from the first position to the second position. Then, the passing wheel may cause both the support element and the pushing element to move out of the path of the wheel. When the wheel has passed, the pushing element may disengage the wheel and allow itself and the support element to return to the first position.

In one situation, the pushing element is positioned higher than the support element. The pushing element is positioned to engage the wheel at a height (along a vertical axis) closer to that of the rotational axis of the wheel, as that position of the wheel will be further along the direction of movement thereof than portions farther from the axis of rotation. The pusher element may engage the wheel before the wheel reaches the support element.

The pushing element may extend farther, in the projection and at the determined distance, along the longitudinal axis than any portion of the support element. In this manner, when the pushing element engages the wheel, the wheel will not engage the support element.

In one embodiment, the system may include a sensor for sensing an obstruction, such as a wheel, in the determined distance from the longitudinal axis and in the vicinity of a determined support element, the pertaining actuating element being that can, based on an output of the sensor, actuate the determined support element from the first position to the second position.

The sensor may sense obstructions, such as wheels, at a longer distance from the axis. Also, the sensor may be positioned to detect the obstruction before the obstruction reaches the pertaining support element to give the actuating element time to, if not automatic, react and bring that support element to the second position. If the wheel is always expected to travel in one direction on the rail, the sensor may be positioned to detect the wheel a position before the wheel arrives at the position at which the pertaining support element engages the rail.

The same sensor may be used for controlling the operation of multiple actuating elements. On the one hand, the wheels of trains, cars and wagons aways are provided in pairs so that the position of one wheel on one rail will dictate the position of a wheel on the other rail. On the other hand, the velocity of the wheel vis-à-vis the system may be determined so that the timing of the operation of the individual actuating elements may be determined.

In one embodiment, the system may include a control circuit. The control circuit may, based at least in part on a received signal, control the actuating elements of connection elements to actuate the support elements to (or from) the second position. Actuating all support elements to the second position would not likely allow the system to support itself on the rails. The system may then enter this mode and sit, in the projection onto the plane, between the rails to not be in the way of train wheels moving along the rails.

This mode may be entered when the system has completed a task or when a malfunction is detected. Also, if a fast-moving train is approaching, the system may enter this mode if it is not able to operate the actuating elements sufficiently fast enough for the wheels to be able to pass while at least some of the support elements are in the first position. Clearly, other reasons may exist for entering this mode and thus avoiding interaction with the train wheels.

A second aspect of the disclosure relates to a method of operating the system according to the first aspect. The method may include providing the system on the first and second rails of a railway track with the support elements in the first position and engaging the first and second rails, the system passing a pair of wheels of a railway car standing on or moving along the first and second rails, by, for each support element: when the support element approaches a wheel, the pertaining actuating element actuates the pertaining support element to the second position and/or when the support element has passed the wheel, the pertaining actuating element actuates the pertaining support element to the first position.

The wheels(s) of the train/car/wagon may travel along the rails, where the system, such as the frame, may remain stationary in relation to the rails or it may itself move along the rails. A train/car/wagon often has multiple axles and wheels. These may be positioned in pairs of wheels positioned at the same position along the rails (an axle, a line or axis between the two wheels is perpendicular to the direction of the rails). Thus, the support elements on either side of the frame may be operated similarly and simultaneously.

The first and second positions are as described above. A support element may initially be in the second state so that it needs not initially move away from an approaching wheel but will want to engage the rail after the wheel has passed. Also, a support element may not need to re-engage the rail after passing of the wheel. Situations exist where it may be desired to have only a minimum number of support elements engage the rails while maintaining a sufficient or desired position and support of the frame.

The method may include both the actuating of the support element to the second position and to the first state. The wheel may approach a support element when a relative velocity is seen between the two. Either element—or both—may move in relation to the rails. When the wheel approaches a support element (or vice versa), the pertaining actuating element actuates the pertaining support element to the second position to allow the wheel to pass the position at which the support element engaged the upper surface of the rail. The second position is selected so that the support element, and in some situations any part of the support structure or system, does not interfere with, such as touch, the passing wheel.

In some situations, no part of the system touches any part of the wheel or the train/car/wagon when the wheel and system pass each other. In other situations, the system may include an element, such as a pusher element, engaging the passing wheel in order to actuate the support element to the second position.

In response to the support element having passed the wheel, or vice versa, the control circuit may cause the pertaining actuating element actuates the pertaining support element to the first position to again support the support element on the rail, often at the same position (in relation to the frame). In one embodiment, the system moves along the rails. The train/wagon/car may be stationary in relation to the rails, or they may move along the rails. Alternatively, the system may be stationary in relation to the rails where the train/wagon/car move along the rails.

In one embodiment, the support elements are support rollers or tracks, the system may have a drive unit connected to at least two of the support rollers. During use, the drive unit may provide motive power or may rotate the coupled support rollers/tracks. In this manner, the system may be able to move along the rails. A plurality of support rollers/tracks are driven, as this may allow some to be in the second position while others are in the first position.

In one embodiment, the actuating element of at least one connection element actuates the support element to the second position by moving a second portion, including the support element, in relation to a first portion fixed in relation to the frame. As mentioned above, the first portion may form part of the frame. The second portion may allow the support element to rotate in relation to the first portion or a part of the second portion.

In one embodiment, a pushing element of the actuating element of at the least one connection element engages one of the wheels, is pushed by a relative velocity between the wheel and the pushing element and actuates the pertaining support element from the first position to the second position. Thus, no extra power source is required, as the torque or force required may be derived from the relative movement between the wheel and the pushing element.

In one embodiment, a sensor outputs a signal when a support element and the wheel are a determined distance relative to each other, the pertaining actuating element receiving the signal and actuate the determined support element from the first position to the second position. A suitable sensor may be a camera, optical sensor, magnetic sensor, galvanic sensor, hall sensor, or the like. The sensor may sense a distance to a wheel or obstacle, a position of a wheel, a velocity of the wheel, a direction of movement of the wheel, and the like. The control circuit may actuate the actuating element to switch positional modes of the support element. The control circuit may receive a signal and control the actuating elements of one or more connection elements to actuate all support elements to the second position. This mode may be activated if a malfunction of the system is detected or a fast-moving train is expected. Another suitable mode for the control circuit to select is a safe-mode in which movement or actuation may injure or cause harm. In one embodiment, the control circuit may not initiate movement or actuation without assurance that a determined area is clear.

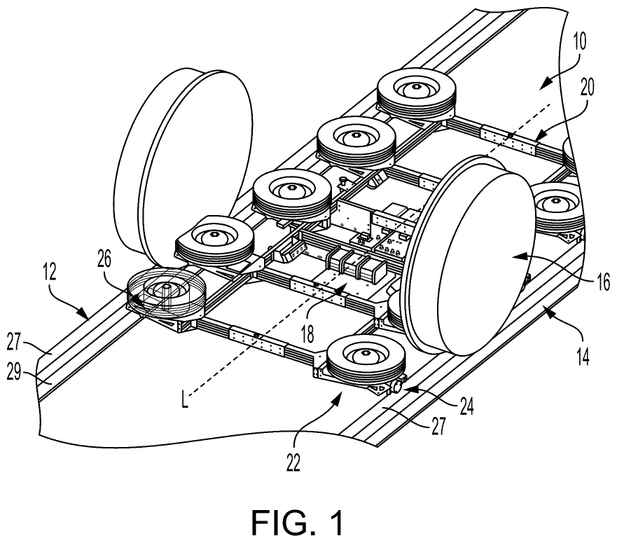

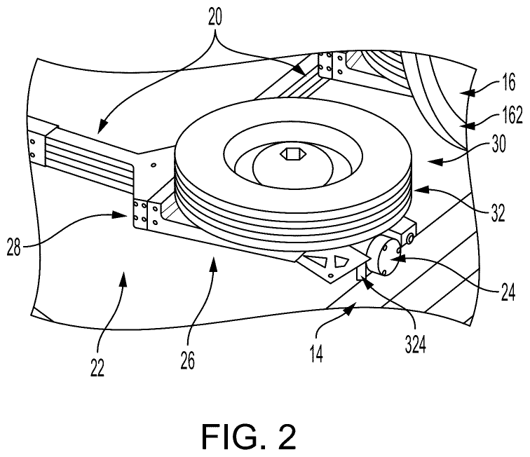

FIG. 1 illustrates a system 10 that can travel along first and second rails 12, 14, of a railway track, on which trains and cars may travel, each on multiple sets of wheels 16, which are supported on the rails. The system may include a frame 20 and support structures 22 distributed to have five support structures on one side of a longitudinal axis L, and another five support structures on the other side thereof. As is seen in FIG. 2, each support structure has a support roller 24 that can engage a top portion 27, or running surface, of the pertaining rail, so as to support the system when driving along the track. In an alternative embodiment, the support rollers engage a foot portion 29 on the inside of the track so as to support the system when driving along the track.

Railway wheels are supported on the top of the rails, so that the support rollers cannot easily move along the rails below a railway car. Also, the railway wheels have an inner protrusion 162, extending downwardly, relative to the running surface, from the wheel and on the inner side of the rail. This is for ensuring that the train/car/wagon/truck stays on the track, but this protrusion requires the support roller to be removed from engagement with the rail when passing a wheel.

The support structure may include two portions which are movable in relation to each other. A first portion 28 is attached to the frame and another, second portion 26, is rotatably connected to the support roller. In this embodiment, the second portion is translatable, perpendicular to the longitudinal axis, L, in relation to the first portion and the frame, so that the support roller is moved inwardly of the rail to allow the wheel to pass without damaging the support roller. The support roller may be moved sufficiently far inwardly to not engage with the wheel. This position is called the “second” position of this roller, where the position illustrated, where the roller rests on the rail, is called the “first position”.

A drive unit 18 may provide motive effort to some of or all of the support rollers to drive the system along the rails. When a sufficient number of support structures are provided on either side of the axis, L, the system is able to move between multiple pairs of wheels while a sufficient number of support rollers engage the rail so that the system may both remain supported by the rails and be able to move along them while different ones of the support structures bring the individual support rollers from the first position to the second position and back to the first position.

The first and second positions may be defined by the distance from the support roller to the axis L, such as when the elements are projected onto a horizontal plane, or a plane defined by the rails. When in the first position, the support rollers are, in the projection, at or on the rails, whereas in the second state, they are closer to the axis L. The threshold distance thus may be any distance between the axis L, often between relevant portions of the frame, and the innermost portions of the rails or the railcar wheels on the rails (taking into account the projection).

In FIGS. 1 and 2, a larger wheel, a pusher wheel 32, is illustrated, which lies above the support roller and extends farther along the directions of the axis L. The pusher wheel extends at least as far away from the axis L as the support roller. The pusher wheel, in this embodiment, has the operation of moving the support roller from the first to the second position when a wheel 16 approaches. The pusher wheel engages the approaching wheel and is forced toward the axis L by the approaching wheel and the fact that the wheel is mounted on the second portion which is translatable in relation to the portion and the frame. This translation brings the pertaining support roller away from the rail so that the wheel may pass. When the wheel has passed, the pusher wheel disengages the wheel and thus allows the second portion to extend so that the support roller may again support on the upper side of the rail. A spring or other resilient means may be provided for biasing the second portion toward having the support roller in the operational position.

The pusher wheel may not be connected directly to the second portion but may be in a geared relationship so that a relatively small displacement of the roller wheel toward the axis L may bring about a larger displacement in the same direction of the support roller.

Small rollers 324 may engage the inner surface of the rail. These are alternatives to the projections of the wheels and have the purpose of ensuring that the rollers do not pass to the inner or outer sides of the rails. Alternatively, projections may be provided as on the wheel. The second portions may be biased toward the rail to take into account situations where the distance between the rails varies slightly.

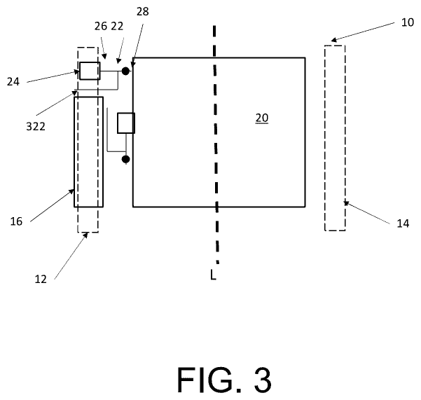

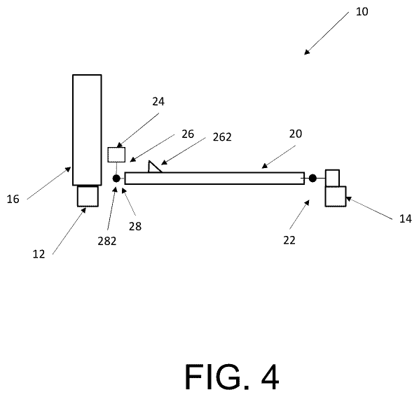

Multiple other manners exist of moving the supporting roller between the first and second position. Some of these manners are described in relation to FIGS. 3-4.

In FIG. 3, another manner of bringing the support roller from the first to the second position is illustrated in the system seen from above. Again, the frame is attached to the support structure having a first portion fixed to the frame and second portion movably, this time rotatably, attached to the first portion and to which the support roller is rotatably attached.

In this embodiment, the second portion is rotatable around a vertical axis as illustrated. The second portion may have a pusher element 322 positioned on the side of the support roller from which the rail vehicle wheel approaches. In FIG. 3, the rail vehicle wheel moves upwardly along the rail.

It is seen that the pusher element will engage the wheel before it reaches the support roller and will push the portion along the direction of travelling, causing the second portion to rotate, as the support structure supports this rotation.

The pusher element will remain between the support roller and the wheel until the wheel is out of engagement, whereafter the portion will rotate back to the first position.

In FIG. 4, a rotation around a horizontal axis brings the support roller from the first position (illustrated to the right) to the second position illustrated to the left.

Above, the manner of bringing the support roller into the second position has been described using direct engagement of a portion of the system and the approaching train car wheel. Naturally, other manners are useful also, such as a sensor 262 that can sense or detect the arriving wheel, such as a position thereof. This sensor may output a signal to the control circuit, which may operate a actuating element 282 that can bring the pertaining support roller into the second position and/or between the first and second positions. This sensor may be image based, sound based or may be of any other type.

One sensor is not required for each support structure, if the velocity of the wheel is known, relative to the system, such as if the train car including the wheel is stationary vis-à-vis the rails where the system may know its own speed vis-à-vis the rails, such as by controlling its drive. In such situations, the position of the wheel vis-à-vis each individual support structure on the same rail may be known over time, so that the wheel may be detected when approaching the system proper and then, individual support structures may be operated at determined points in time to allow the wheel to pass. This pass event may be accomplished without damage to the system.

In one embodiment, the support roller may have a square cross section in a plane including the axis of rotation. In another embodiment the support roller may have a conical cross section in that plane. This may be relevant e.g. when the translation of FIG. 1 is seen, as the frame and/or portions may not be perfectly stiff, so that the support roller when approaching the rail when being brought back to the first state, may be slightly offset downwardly, where the conical shape may assist in ensuring that the roller again engages the upper side of the rail.

Another reason for having conical rollers is that they, when paired with a solid axle or a mechanism that makes left and right rollers turn the same amount, keep the frame centered between the rails. With cylindrical rollers, it can be advantageous to actively steer to stay on the rails. With coupled conical rollers, when the system starts to deviate to one side, then the roller on that side engages the rail with a larger diameter than the roller on the other side. Because the two rollers are coupled, the larger diameter makes the roller on the side toward which the system has deviated move farther than the roller on the other side, steering the system back to center.

In one embodiment, the control circuit may control the support structures to bring the corresponding support rollers to the second state. When all support rollers go to the second state, the system will no longer be supported by the rails but may fall to the ground between the rails. This may be a safety feature allowing the system to remain intact in situations where trains and cars travel on the rails. If, for example, a train is approaching at a speed so fast that the support structures are not able to react sufficiently, this mode may be assumed so that the system is not destroyed by the train.

In the above embodiments, the system has been described using support rollers. Naturally, alternative types of elements may be used, such as tracks. Also, above, a drive is described rotating at least some of the support rollers to move the system along the rails. Clearly, other types of drives may be used, such as drives engaging the wheels, rail vehicles/wagons, the ground or the rails in other manners, so that the support rollers/tracks need not be driven. Actually, the above support rollers may be replaced by other support elements than rollers, such as non-rotating elements, which may slide along the rails. Sliding may not even be required, as the system may be that can sit in a stationary manner on the tracks where the train/car/wagon/wheels move along the track.

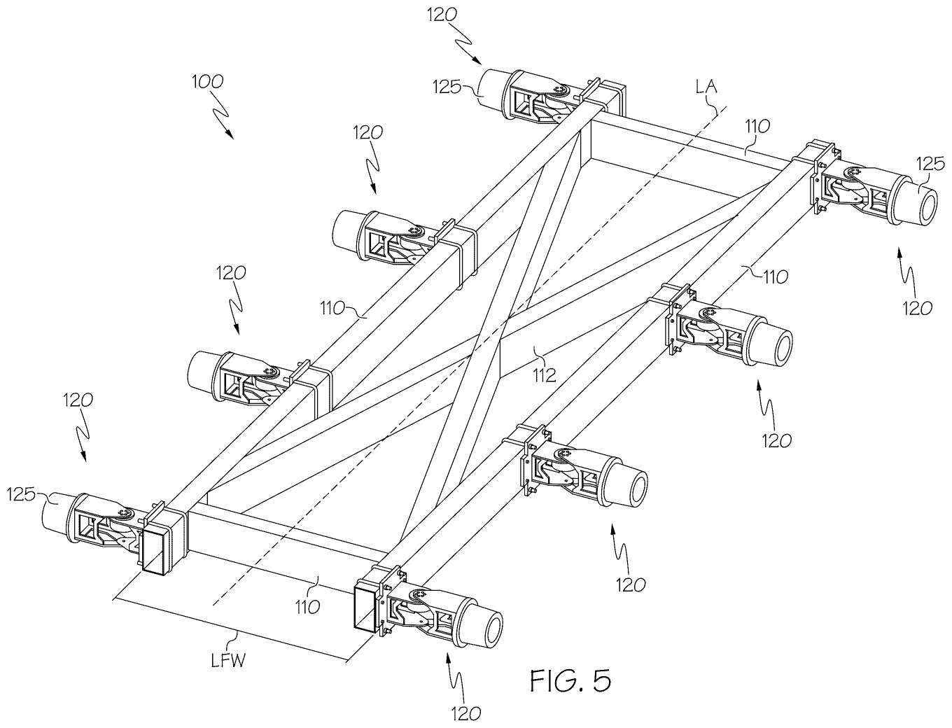

FIG. 5 illustrates a vehicle 100 for traveling along a railway rail. The vehicle is capable of traversing underneath of a rail vehicle and/or permitting a rail vehicle to traverse overtop it. The vehicle may include a frame 110 and a plurality of connection elements, or articulatable arms 120 extending from the frame. The frame defines a lateral frame width LFW that is less than the distance between a pair of rails of a railway, for example. A suitable frame may be rectangular in shape. The frame has cross bracing 112 to provide rigidity to the frame. In various aspects, the cross bracing provides mounting locations for various railway maintenance components, as discussed in greater detail elsewhere herein.

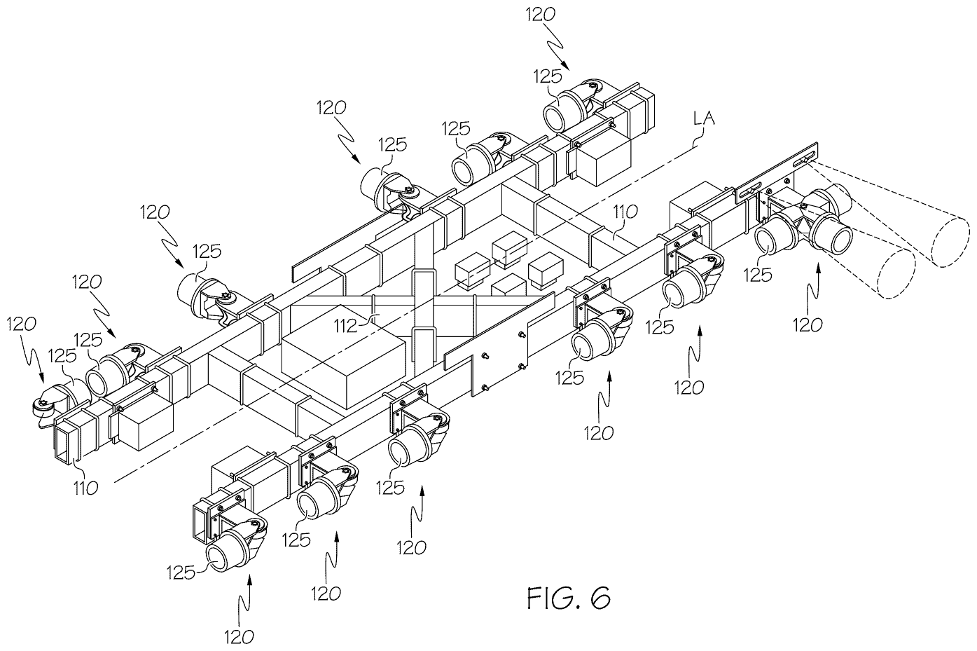

The vehicle may include eight articulatable arms with four articulatable arms positioned on either side of a longitudinal axis LA defined by the frame. In another embodiment, as illustrated in FIG. 6, a vehicle 200 may include twelve articulatable arms in six sets with pairs of articulatable arms positioned on either side of the longitudinal axis LA of the frame. In another embodiment, a vehicle can include at least six articulatable arms with three articulatable arms positioned on either side of the longitudinal axis LA of the frame. In another embodiment, only four arms (e.g., with two on each side of the frame) may be required to traverse underneath of a rail vehicle or for a rail vehicle to traverse overtop the vehicle due to the staggered nature of the articulatable arms, for example.

In some instances, as shown in FIGS. 5 and 6, each arm is positioned directly across from a corresponding arm on the other side of the frame. Alternatively, the articulatable arms on one side of the frame may be staggered relative to the arms on the other side of the frame. The articulatable arms may positioned in an alternating pattern or a zigzag pattern with respect to the frame.

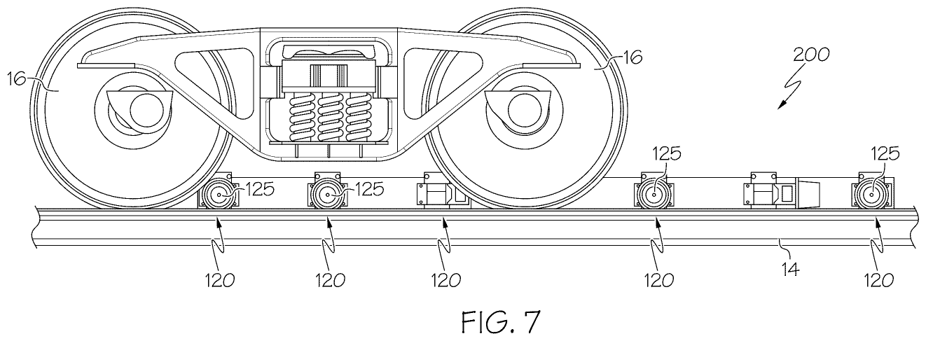

FIG. 7 illustrates the vehicle positioned on railway rails with wheels of a railcar positioned on the railway rails. As discussed in greater detail below, each articulatable arm may include a support element, or flanged wheel connected to the frame by the articulatable arm. In a first configuration of the articulatable arm, the flanged wheel is engaged with one of the rails of the railway. In one embodiment, when one or more than one flanged wheel is engaged with the rail of the railway, the vehicle can be driven along the railway when the flanged wheel is rotated about its respective rotation axis by its respective motor. In one embodiment, one or more than one of the flanged wheels engage the top surface, or running surface, of the rail of the railway in the first configuration. In an alternative embodiment, one or more than one of the flanged wheels engage the foot portion of the rail of the railway. As the vehicle approaches the wheels of the railcar, each of the articulatable arms is that can be actuated, for example sequentially, to move the flanged wheels out of the path of the railcar and permit the vehicle to pass along the railway rail underneath the railcar.

The vehicle may be stationary while the railcar moves toward and traverses across and over the vehicle. Alternatively, the railcar may be stationary while the vehicle moves toward and traverses across and under the railcar. Alternatively, the vehicle and the railcar may both be moving along the rail of the railway in the same direction, or opposite directions, where one traverses the other. In any event, the articulatable arms are that can be actuated to move the flanged wheels out of the path of the wheels of the railcar to permit non-disruptive movement of the vehicle and the railcar along the rail of the railway while providing support to the vehicle to remain supported on the rail of the railway.

Referring now to FIG. 8, each articulatable arm may include a first joint portion 122 attached to the frame and a second joint portion 124 rotatably attached to the first joint portion about an articulation axis AA. In one embodiment, the first joint portion and the second joint portion are rotatably attached by an articulation pin 127. Further, the flanged wheel is rotatably attached to the second joint portion such that the flanged wheel is rotatable relative to the second joint portion, as well as the first joint portion and the frame, about a rotation axis RA. The articulatable arm may include a motor 126 fixed to the second portion with a rotary element of the motor attached to the flanged wheel such that the motor is that can drive the flanged wheel about the rotation axis RA relative to the second joint portion.

Further to the above, the articulatable arm may include an actuator 128 positioned intermediate the first joint portion and the second joint portion. In other embodiments, the arm may include a motor or other propulsive device. In one embodiment, the actuator is attached to the first joint portion with a rotatable portion of the actuator, such as an off centered pin, attached to the second joint portion. The actuator is that can rotate the second joint portion and the flanged wheel relative to the first joint portion and the frame about the articulation axis AA.

Alternatively, the motor can be fixed to the frame. The actuator may be powered by the motor or a separate motor. In an embodiment, the actuator acts against a biasing member or spring that can return the second joint to an unarticulated position absent an actuation force.

A plane of articulation about the articulation access is perpendicular to a plane of rotation about the rotation axis RA of the flanged wheel. Accordingly, the plane of articulation is a horizontal plane parallel to the ground. Alternatively, the articulatable arm may be attached to the frame ninety degrees from the orientation shown in FIG. 8 such that the articulation axis AA is parallel to the ground and the plane of articulation is perpendicular to the ground. In an embodiment, the articulatable arm may be attached to the frame in a manner that causes the plane of articulation to define an angle with the ground in a range of from about 0 degrees to about 90 degrees.

Each flanged wheel of each articulatable arm of the plurality of arms is independently and/or selectively actuatable between the engaged position and the disengaged position. Alternatively, two or more of the flanged wheels, as a pair, can be synchronously actuated between the engaged position and the disengaged position.

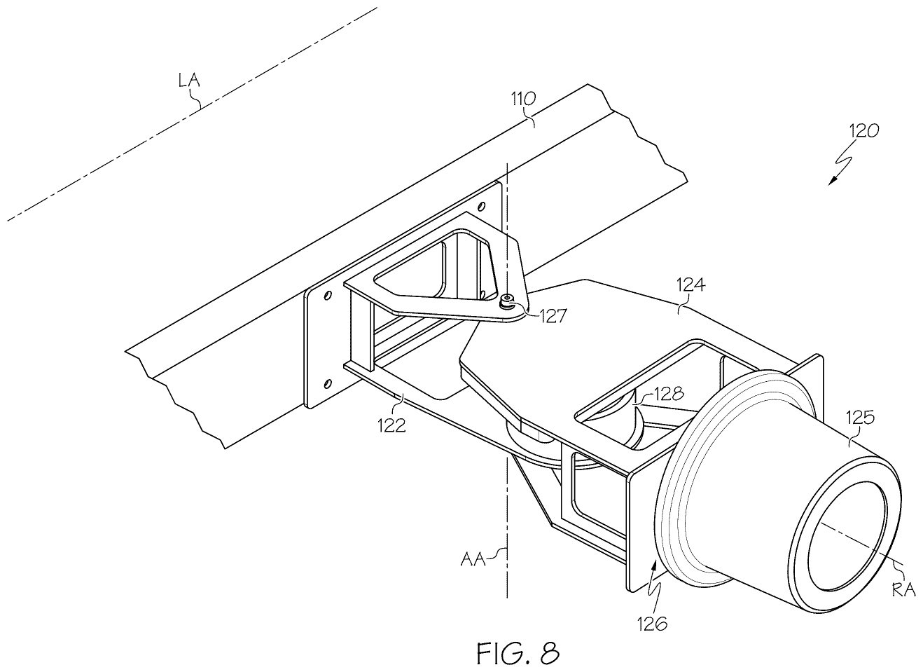

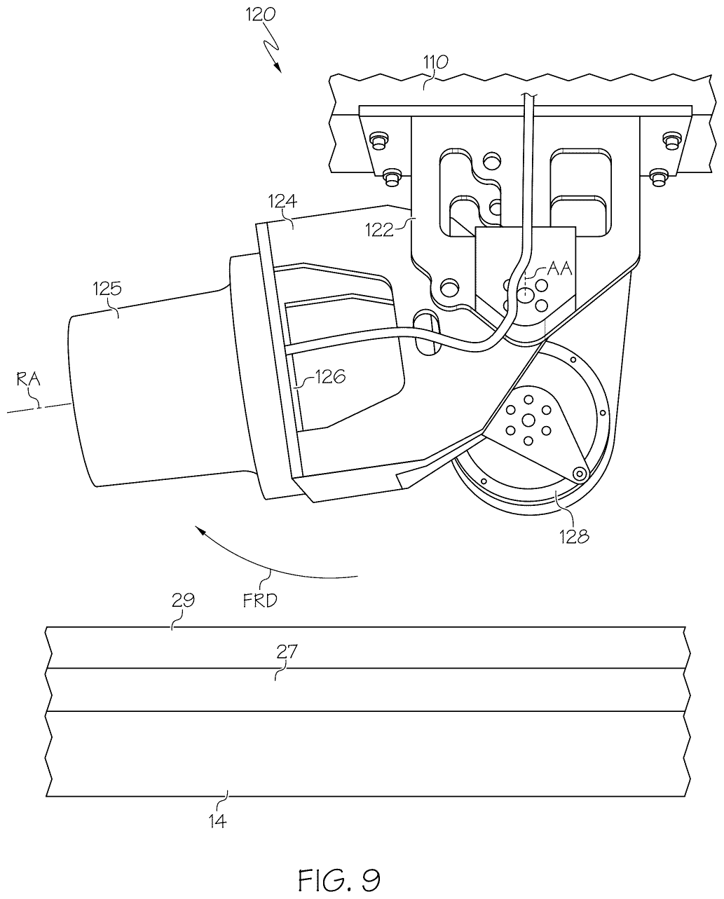

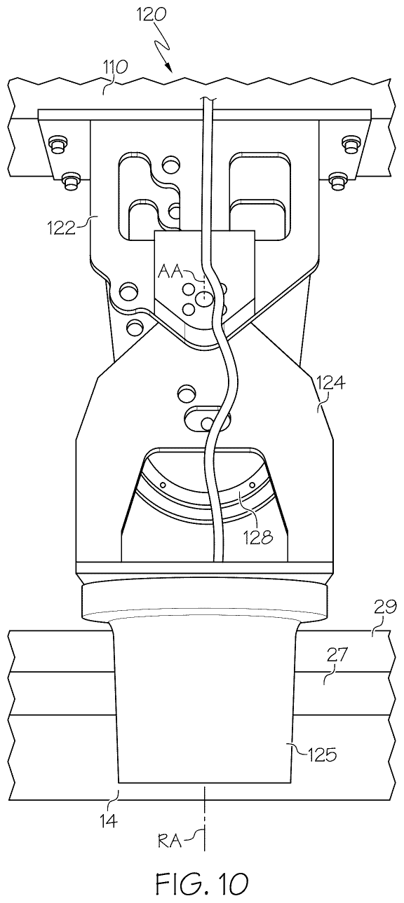

Referring to FIGS. 9-11, one of the articulatable arms is illustrated in various orientations. Specifically, FIG. 10 illustrates the articulatable arm in an unarticulated orientation, in the first configuration, with the flanged wheel in the engaged position resting on the top portion, or resting surface, of the rail of the railway. When the flanged wheel is in the engaged position, the first joint portion and the second joint portion of the articulatable arm are aligned, or substantially aligned, with each other as shown in FIG. 10. In the engaged position, the flanged wheel can provide tractive effort onto the resting surface of the rail in response to an actuation of the motor mounted to the second joint portion of the articulatable arm. In an alternative embodiment, one or more than one of the flanged wheels rest on the foot portion on the inside of the rail of the railway when the articulatable arm is in the unarticulated orientation, in the first configuration, with the flanged wheel in the engaged position. In this engaged position, the flanged wheel can provide tractive effort onto the foot portion of the rail in response to an actuation of the motor mounted to the second joint portion of the articulatable arm.

FIGS. 9 and 11 illustrate the articulatable arm in a second configuration with the flanged wheel disengaged from the rail of the railway. In FIGS. 9 and 11, the articulatable arm has been rotated away from the rail of the railway in opposite directions. In FIG. 9, the flanged wheel has been rotated in a first rotational direction FRD from the unarticulated orientation (FIG. 10) to a first articulated orientation. Conversely, in FIG. 11, the flanged wheel has been rotated in a second rotational direction SRD, opposite the first rotational direction FRD, from the unarticulated orientation (FIG. 10) to a second articulated orientation. The first and second articulation orientations are ninety-degree articulation orientation, in opposite directions. Alternatively, the first and second articulation orientations can define any angle suitable to disengage the flanged wheel from the rail to clear the wheel of the railcar. In some aspects, the angle is selected from a range of about 30 degrees to about 90 degrees, for example.

In various aspects, the flanged wheel of one or more than one of the articulatable arms can be drivingly rotated about its respective rotation axes RA in both the first configuration and the second configuration. In such instances, when the flanged wheel is transitioned from a disengaged position (e.g., FIG. 9 or 11) to the engaged position (e.g., FIG. 10), the rotation of the flanged wheel about axis RA may help reengage the flanged wheel with the rail of the railway.

As discussed above, the vehicle may be stationary with the railcar passing by the vehicle. When the vehicle is stationary, the flanged wheels are not actively rotating about their respective rotation axes. As such, when the articulatable arm actuates to move the flanged wheel out of the path of the wheel of the railcar, the flanged wheel may be actively braked by the motor of the articulatable arm to prevent the vehicle from moving along to the railway. In another aspect, the flanged wheels may be free to rotate about their respective rotation axes even when the vehicle is stationary (e.g., the flanged wheels are not being actively braked or actively rotated by their respective motors).

Further to the above, In one embodiment, the flanged wheels may be conical in shape, e.g. tapering smaller further away from the frame. In such instances, the conical shape can provide a ramping effect to help the flanged wheel reengage the rail of the railway when transitioning from the second configuration to the first configuration.

As discussed above, the articulatable arm may be attached to the frame ninety degrees from the orientation shown in FIG. 8. In such instances, the actuator of the articulatable arm can be actuated with one or more than one of the flanged wheels in the engaged position to lift the frame of the vehicle relative to the rail of the railway. When some, if not all, of the articulatable arms are actuated in this manner, the frame of the vehicle can be lifted up high enough to clear street crossings, railway switches, or other obstacles in between the rails of the railway. Further, In one embodiment, the articulatable arm can be actuated with the flanged wheel in the engaged position to drop the frame of the vehicle down in between the rails of the railway to avoid low hanging portions of a railcar above the frame of the vehicle, for example. In one embodiment, actuation in this manner may be utilized to completely disengage the flanged wheels of the vehicle from the rails to allow the entirety of the vehicle to be positioned below the resting surface of the rails of the railway.

Further to the above, a linear actuator may be positioned between one or more than one of the articulatable arms and the frame of the vehicle. In one embodiment, the linear actuator is mounted to the frame with an actuatable portion attached to the articulatable arm. In such instances, the linear actuator can be actuated to move the entirety of the articulatable arm up and down relative to the frame (i.e., orthogonal to the longitudinal axis of the frame). In various aspects, the linear actuator permits the frame of the vehicle to be raised up or down relative to the rails of the railway to avoid objects that may be in the path of the vehicle. For example, the linear actuator may be used to lift the frame of the vehicle high enough to clear street crossings, railway switches, or other obstacles in between the rails of the railway. Moreover, the linear actuator may be used to drop the frame down in between the rails of the railway to avoid a low railcar, for example.

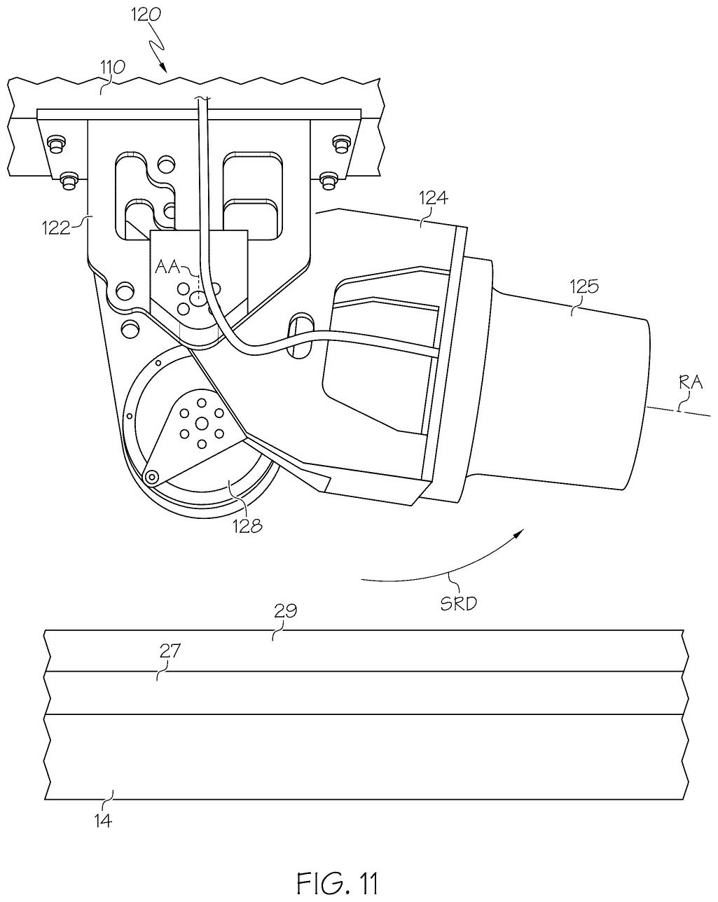

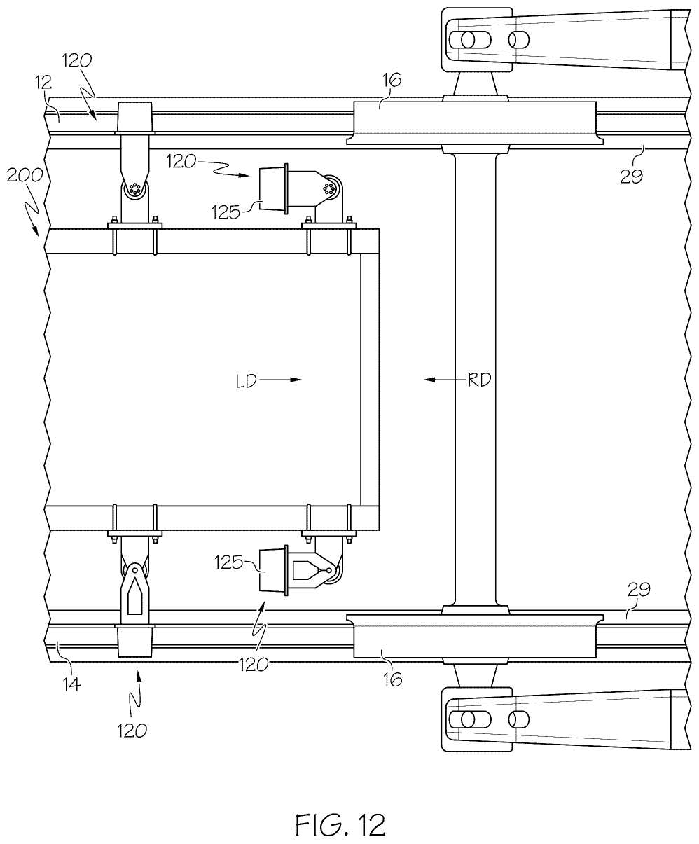

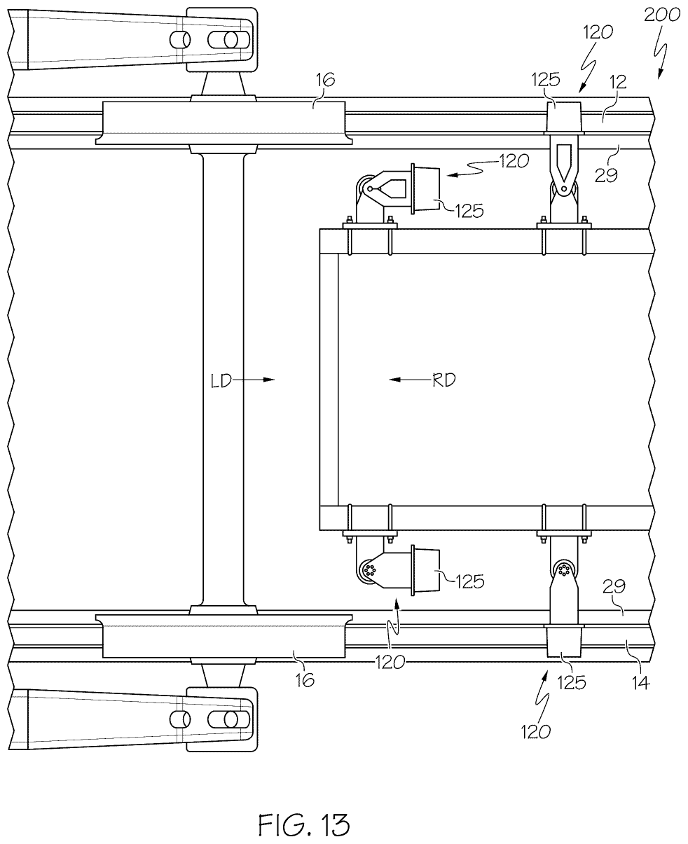

In one embodiment, each of the articulatable arms is that can be actuated to move the flanged wheel from the engaged position toward the disengaged position in a direction that is away from the wheel of the railcar no matter the relative movement directions between the vehicle and the wheel. For example, referring to FIG. 12, when the vehicle approaches a stationary wheel from left direction LD, the flanged wheels on either side of the frame can be rotated out of the path of the wheel of the railcar in a direction that is away from the wheel of the railcar. Similarly, if the rail vehicle wheel approaches the stationary vehicle from the right direction RD, the flanged wheels on either side of the frame can be rotated out of the path of the wheel of the railcar in a direction that is away from the wheel of the railcar. Similarly, the rotation direction is away from the rail vehicle wheel when the vehicle approaches a stationary railcar wheel from the right direction RD or when the rail vehicle wheels approach a stationary vehicle from the left direction LD, see FIG. 13.

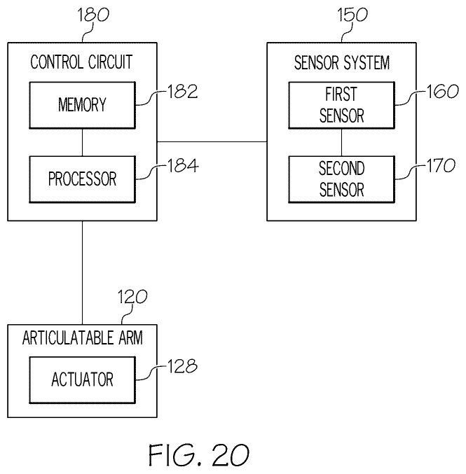

In various aspects, the direction of rotation of each of the flanged wheels may be away from the wheels of the railcar when both the vehicle and railcar wheels are moving along the rail of the railway relative to each other. In one embodiment, the direction of rotation of the flanged wheel being away from the wheel of the railcar may provide additional time for actuation of the articulatable arm to occur to prevent the flanged wheel from interfering with the wheel of the railcar, e.g., as compared to the flanged wheel rotating toward an approaching wheel of the railcar, or vice versa. Accordingly, the direction of rotation can be selectively determined by a control circuit (FIG. 20) to increase the time available for actuation of the articulation arm to move the flanged wheel away from the rail without, or with minimal, interference with the wheel of the railcar.

In use, when the articulatable arm approaches a wheel of a rail vehicle, or vice versa, the actuator of the articulatable arm is actuated to transition the flanged wheel of the articulatable arm from an engaged position (e.g., FIG. 10) to a disengaged position (e.g., FIG. 9 or 11). Each articulatable arm may be selectively (e.g., sequentially) actuated as the oncoming wheel is detected. In various aspects, while one articulatable arm is actuated to its second configuration to avoid the wheel of the railcar, the remaining articulatable arms can remain in their first configurations with the flanged wheels engaged with the rail to support the vehicle on the rail of the railway. In one embodiment, the frame of the vehicle is positioned the same vertical distance relative to the pair of rails of the railway as each of the articulatable arms are selectively (e.g., sequentially) transitioned between the first configuration and the second configuration as the vehicle passes underneath the railcar, or as the railcar passes overtop the vehicle.

In one embodiment, the frame of the vehicle may sag slightly in the region of two opposing articulation arms when the two opposing articulation arms are moved into their respective second configurations at the same time. In such instances, the other articulations arms, in their first configurations, support the vehicle so that the frame does not fall in between the rails to enable the two opposing flanged wheels to re-engage the rails of the railway once the wheel of the railcar passes by. In the event that the frame sags slightly in the region of opposing articulation arms in their second configurations, the flanged wheel of each articulation arm may be drivingly rotated about their respective rotation axes to assist in re-engaging the rail of the railway when the articulatable arm is moved from the second configuration back into the first configuration. Moreover, the flanged wheels may be conical in shape which can aid the flanged wheel to reengage the rail of the railway when the articulatable arm is moved from the second configuration to the first configuration.

In various aspects, the actuation of the actuator may be initiated by a sensor, or other detection system, which detects the presence of a wheel, or wheels, of a railcar in the path of the flanged wheel in close proximity to the flanged wheel, as discussed in greater detail below.

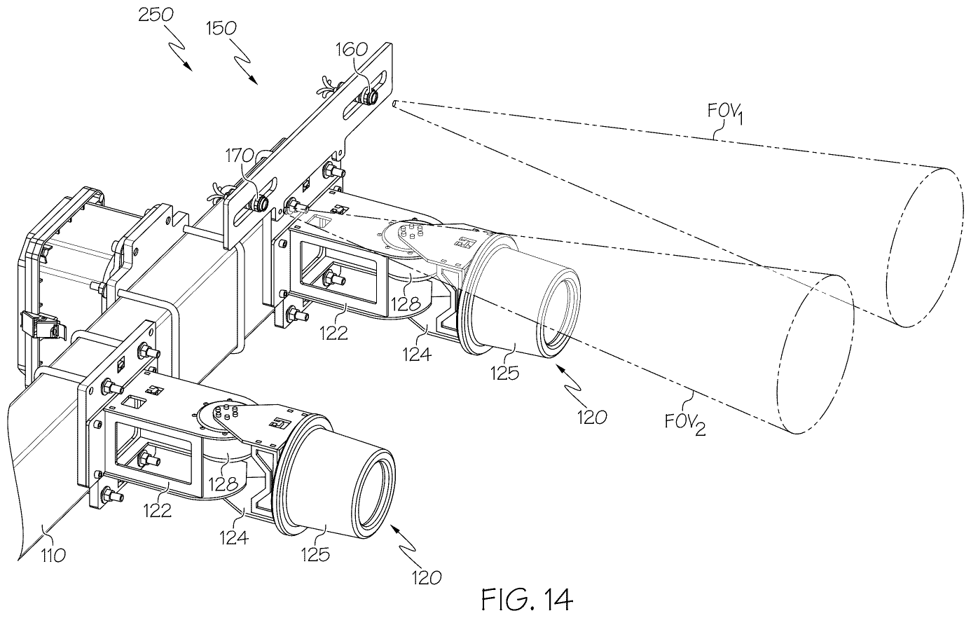

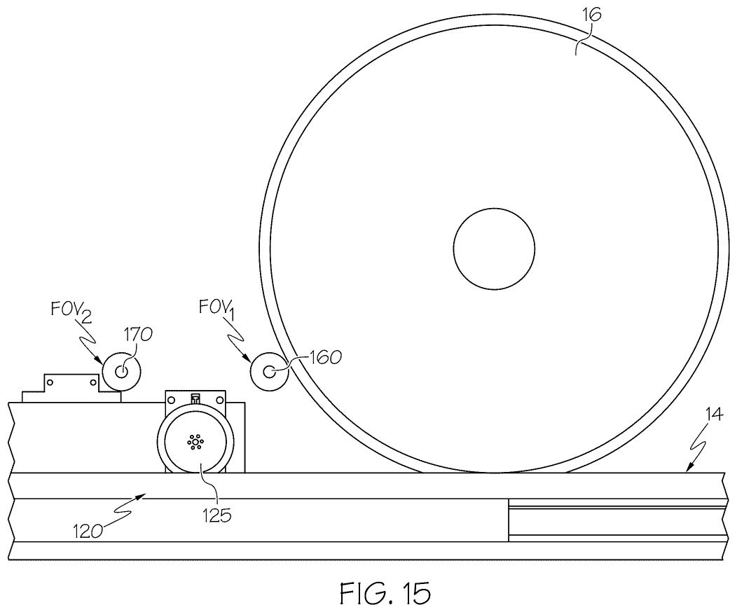

In order to initiate the actuation of the articulatable arms, the vehicle may employ one or more sensors to detect the presence of a nearby wheel on the rail of the railway. For example, a sensor system 150 may include a first sensor 160 and a second sensor 170. The sensor system may mount to the frame on either side of the articulatable arm, e.g., on either side of the flanged wheel in the engaged position as shown in FIGS. 14-19. Each articulatable arm may have a dedicated sensor system. In any event, the first sensor that can detect, or sense, objects within a first field of view FOV₁ and the second sensor is that can sense objects within a second field of view FOV₂. The first sensor, the second sensor, and the actuator of the articulatable arm are in signal communication with each other, for example.

A suitable control circuit 180 (FIG. 20) may include a memory 182 and one or more processors 184 and may execute instructions stored in the memory. In one embodiment, the control circuit may be in signal communication with each of the sensor systems and with each of the actuators of the articulatable arms as shown in the schematic of FIG. 20. In one embodiment, the control circuit may be in signal communication with each of the sensor systems, with each of the actuators of the articulatable arms, and with the linear actuator. In such instances, the control circuit may receive and interpret sensor input, based at least in part on the sensor input may identify an obstacle, and may respond by selectively causing the linear actuator to move the frame to avoid an obstacle.

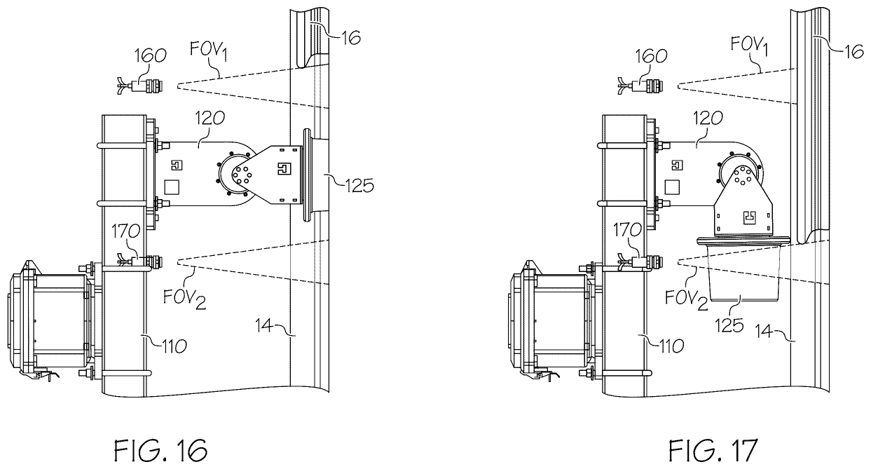

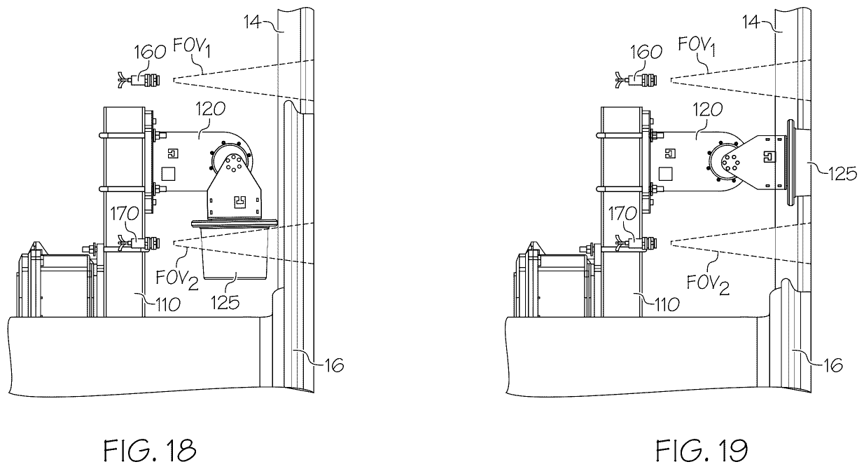

Referring to FIG. 16, when neither the first sensor nor the second sensor detects an obstruction, such as a wheel of a railcar in the path of a flanged wheel 125 of the vehicle, the flanged wheel is in the engaged position. Referring to FIG. 17, when an object, such as the wheel of the railcar initially enters the first field of view FOV₁ of the first sensor, the first sensor sends a signal to the control circuit which in turn actuates the actuator of the articulatable arm to move the flanged wheel from the engaged position to the disengaged position such that the flanged wheel disengages the rail of the railway and moves out of the path of the wheel of the railcar. Further, after the first sensor initially detects the wheel, the second sensor is to detect the wheel upon further movement of the wheel along the rail of the railway and into the second field of view FOV₂, as shown in FIG. 18. When the second sensor detects the wheel of the railcar after the first sensor, the second sensor sends a signal to the control circuit which in turn directs the actuator to maintain the flanged wheel in the engaged position. Upon the second sensor no longer detecting the wheel of the railcar within the second field of view FOV₂, as shown in FIG. 19, the second sensor sends a signal to the control circuit which is that can actuate the actuator to transition the flanged wheel from the disengaged position to the engaged position to reengage the rail of the railway, as shown in FIG. 19.

In various aspects, the size of the first field of view FOV₁ and the second field of view FOV₂ are selected to give the flanged wheel ample time to be actuated out of the way of the wheel of the railcar upon the first sensor initially detecting the wheel of the railcar, and selected to ensure that the wheel of the railcar is clear of the rotating path of the flange wheel prior to transitioning the flanged wheel back into the engaged position to ensure the flanged wheel does not interfere with the wheel of the railcar passing by.

In instances where the second sensor is the first to detect an obstruction, such as the wheel of the railcar, the control circuit can move the flanged wheel out of the way of the wheel of the railcar in the same manner as described above, albeit in reverse due to the second sensor detecting the wheel of the railcar first. Moreover, the sensor system will work in a similar manner to initiate actuation of the flanged wheels when the vehicle is moving along the railway and the wheels of the railcar on the railway rail are stationary. The sensor system will work in a similar manner to actuate the flanged wheels when both the vehicle and the wheel of the railcar are moving along the railway.

In one embodiment, a single sensor may be used having a field of view that is large enough to initially detect the wheel within the field of view in order to give the flanged wheel of the vehicle ample time to rotate to the disengaged position and to initiate the transition of the flanged wheel from the disengaged position back into the engaged position once the single sensor no longer detects the wheel of the railcar within its field of view.

In alternative embodiments, only a subset of the flanged wheels is associated with sensors, and the control circuit is that can perform a hybrid of time-based articulation decisions and sensor-based articulation decisions. The sensors can be limited to one or both of the flanged wheels at the front end of the vehicle Additionally, or alternatively, the sensors can be limited to one or both of the flanged wheels at the back end of the vehicle. The intermediate flanged wheels may lack direct sensor support. The control circuit may determine when to articulate the articulation arms to move the intermediate flanged wheels away from the rail based on the time from receipt of an input sensor associated with another flanged wheel (front/end) assuming a significant change in speed is not detected.

To ensure a sufficient number of engaged flanged wheels are available to support the vehicle on the rail of the railway, a control circuit (FIG. 20) may execute an articulation sequence or pattern. The control circuit may control the instance and direction of articulation of the articulation arms based on sensor input from a sensor system 150 (FIG. 20), the sensor input indicative of upcoming wheel interfaces, for example. In one aspect, the decision to articulate one of the articulation arms, for example in response to a sensor input, can be conditioned upon detecting a sufficient number of engaged flanged wheels, or articulation arms in unarticulated orientation, to support the vehicle on the rail of the railway.

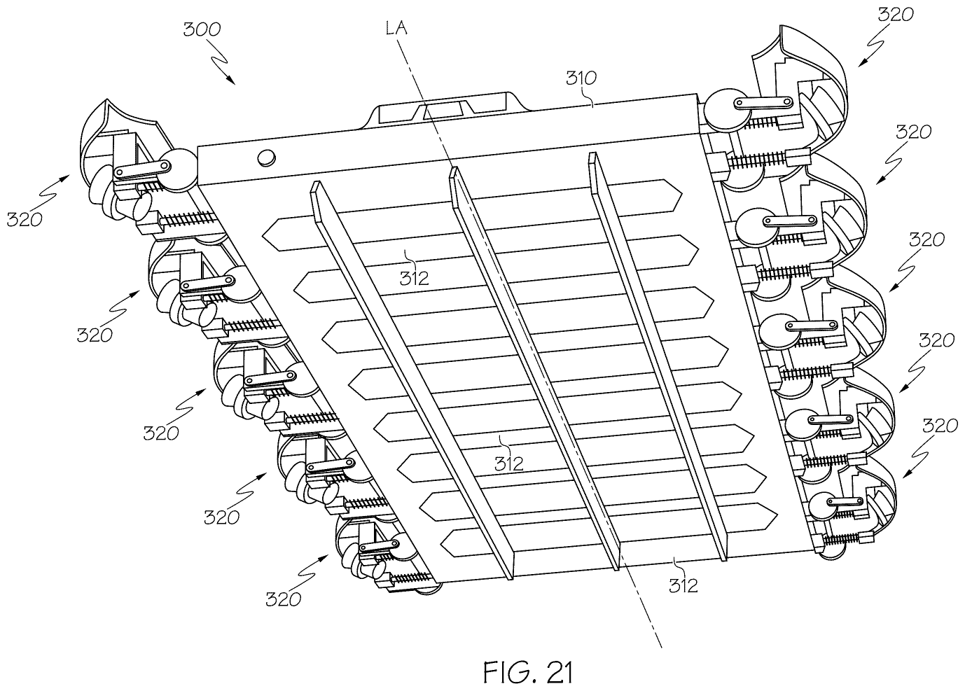

FIG. 21 illustrates a vehicle 300 for travelling along a rail of a railway. The vehicle in FIG. 21 is similar in some respects to the vehicles shown in FIGS. 5 and 6, and is capable of traversing underneath of a rail vehicle and/or permitting a rail vehicle to traverse overtop it. The vehicle may include a frame 310 and a plurality of connection elements, or actuatable arms 320 extending from the frame. The frame defines a lateral frame width that is less than the distance between a pair of rails of a railway, for example. In various aspects, the frame has cross bracing to provide rigidity to the frame. The cross bracing provides mounting locations for various railway maintenance components, as discussed in greater detail elsewhere herein.

The vehicle may include ten actuatable arms with five actuatable arms positioned on either side of a longitudinal axis defined by the frame. In another embodiment, a vehicle can include plural sets of arms. These sets may be directly opposed to each other in one embodiment and may be offset relative to each other in other embodiments.

In some instances, as shown in FIG. 21, each arm is positioned directly across from a corresponding arm on the other side of the frame. Alternatively, the actuatable arms on one side of the frame may be staggered relative to the arms on the other side of the frame. The actuatable arms may positioned in an alternating pattern or a zigzag pattern with respect to the frame.

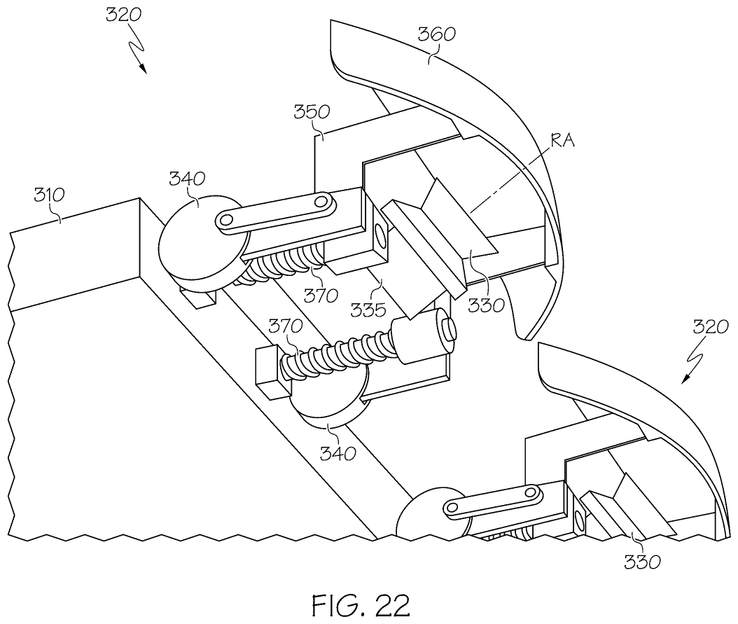

FIG. 22 illustrates an enlarged view of one of the actuatable arms of the vehicle. Each actuatable arm may include a first connector 340 attached to the frame and a second connector 350 extending from the first connector and movable relative to the first connector. The actuatable arm further may include a support element, or flanged wheel 330, and a guide shoe 360 which are mounted to the second connector. Further, the actuatable arm may include a pair of compression springs 370 mounted between the first connector and the second connector. The actuatable arm further may include a direct drive motor 335 for actuating the flanged wheel relative to the frame about a rotation axis RA.

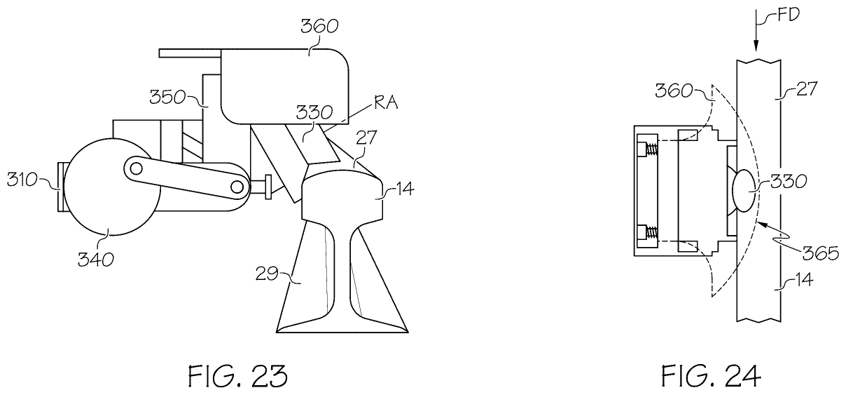

Referring primarily to FIGS. 23-28, In one embodiment, as the vehicle approaches a wheel of a railcar from a first direction FD, each of the guide shoes of the actuatable arms are that can sequentially engage the wheel to move the flanged wheels and guide shoe out of the path of the wheel to permit the vehicle to pass along the rails of the railway underneath the railcar. The vehicle may be stationary while the railcar moves toward and traverses the vehicle. Alternatively, the railcar may be stationary while the vehicle moves toward and traverses the railcar. Alternatively, the vehicle and the railcar may both be moving along the rail of the railway in the same direction, or opposite directions, where one traverses the other.

Referring to FIGS. 23 and 24, when the guide shoe is not engaged with the wheel of the railcar, the actuatable arm is in a first configuration where the flanged wheel is engaged with the rail of the railway. In the engaged position, the flanged wheel is permitted to be rotated about its rotation axis by its respective motor to produce tractive effort onto the rail of the railway. As such, when one or more than one flanged wheel is in the engaged position, the vehicle can be driven along the rails of the railway. In one embodiment, the biasing force of the compression springs biases the second connector away from the first connector and, thus, retains the flanged wheel in the engaged position.

Further to the above, in the illustrated embodiment, the flanged wheel rests on the top portion of the rail of the railway as shown in FIGS. 23 and 24. In an alternative embodiment, in the engaged position, the flanged wheel rests on the foot portion of the rail of the railway.

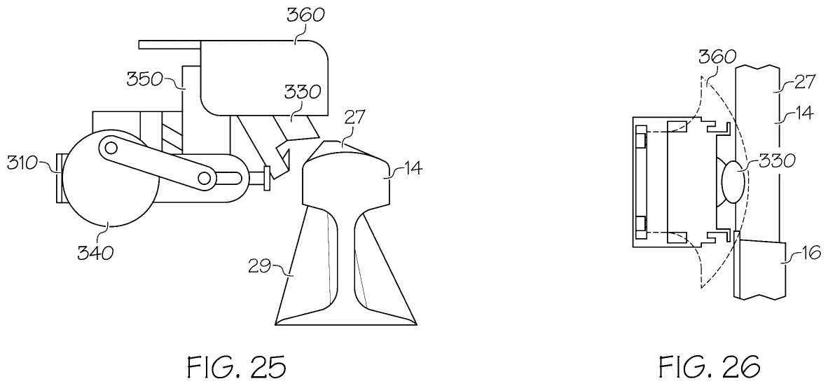

Further to the above, when the guide shoe and the wheel of the railcar initially engage one another, the actuatable arm is transitioned from the first configuration into a second configuration, as shown in FIGS. 25 and 26. As the guide shoe of the actuatable arm and the wheel of the railcar engage each other, the compression springs are compressed to permit the second connector and, thus, the flanged wheel to move away from the rail toward the frame of the vehicle and, thus, to disengage the rail.

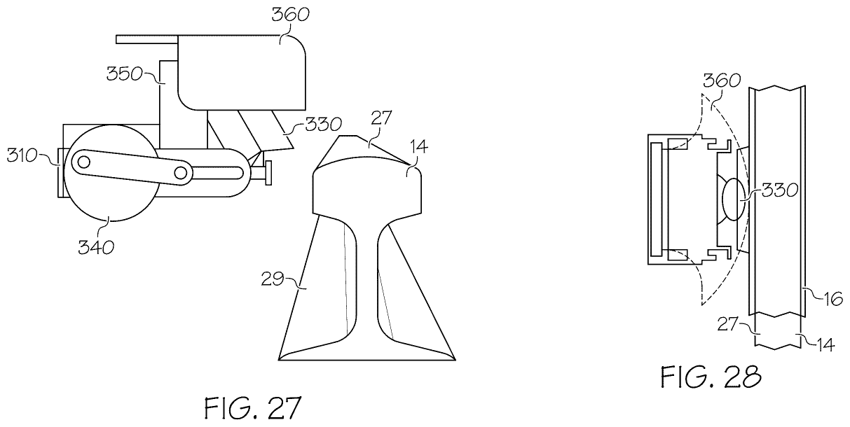

Further to the above, in response to relative movement between the actuatable arm and the wheel of the railcar, the guide shoe may be moved further away from the rail toward the frame of the vehicle to retain the actuatable arm in the second configuration with the flanged wheel disengaged from the rail of the railway as shown in FIGS. 27 and 28. In one embodiment, the guide shoe may remain in contact with the wheel of the railcar until the wheel passes completely by the guide shoe. Upon the wheel of the railcar moving clear of the guide shoe, the compression springs transition the actuatable arm from the second configuration back into the first configuration to reengage the flanged wheel with the rail of the railway, i.e., the same configuration shown in FIGS. 23 and 24.

Referring still to FIGS. 23-28, in one embodiment, the guide shoe defines an arcuate outer surface 365 that permits the wheel of the railcar to gradually engage the guide shoe to transition the actuatable arm between the first configuration (FIG. 23) to the second configuration (FIG. 25). In one embodiment, the guide shoes of the vehicle are replaceable. In any event, each of the guide shoes of the vehicle are that can engage the wheel of the railcar to sequentially transition each actuatable arm, on both sides of the vehicle, between the first configuration and the second configuration to permit the vehicle to pass underneath the railcar.

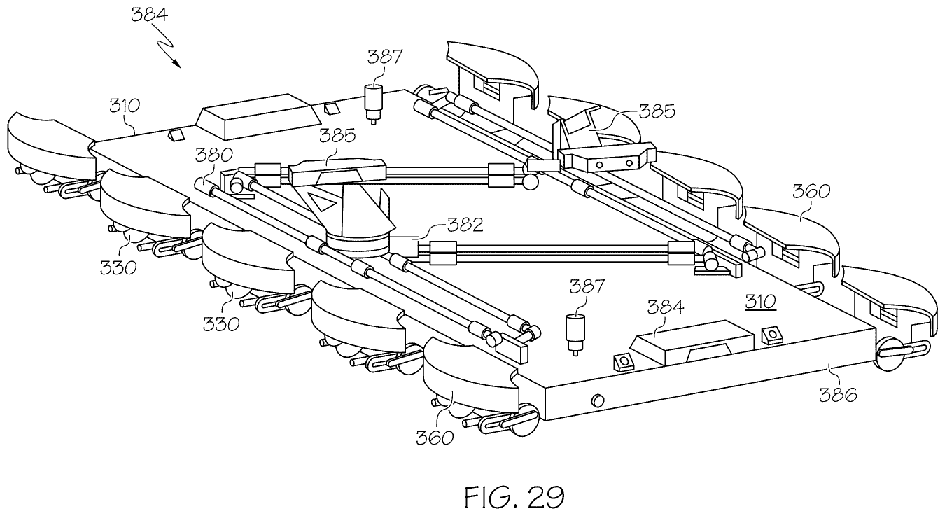

The following description discusses a number of components that can perform various maintenance and/or operational tasks while the vehicle is underneath a railcar. As shown in FIG. 29, the vehicle may include a plurality of manipulators 380 attached to the frame. Suitable manipulators can be high speed multi-axis manipulators that lay flat when the vehicle passes underneath of a railcar and then are that can be actuated to rise up to perform multiple tasks such as, for example, maintenance tasks including manipulating air valves. In one embodiment, the manipulators are used to connect air couplers. In one embodiment, the manipulators include belt driven linear actuators.

In various aspects, the manipulators include one or more than one end effector attached thereto. The end effectors are that can perform operations and/or maintenance on railway cars and systems. The end effectors may include one or more of an integrated yaw drive, a grip for air valve or air hose glad hand, an integrated stereo camera, lighting, and a microphone, for example.

In one embodiment, the vehicle further may include one or more than one microphone 382 attached to the frame portion to detect and pinpoint leaks in railcar air systems.

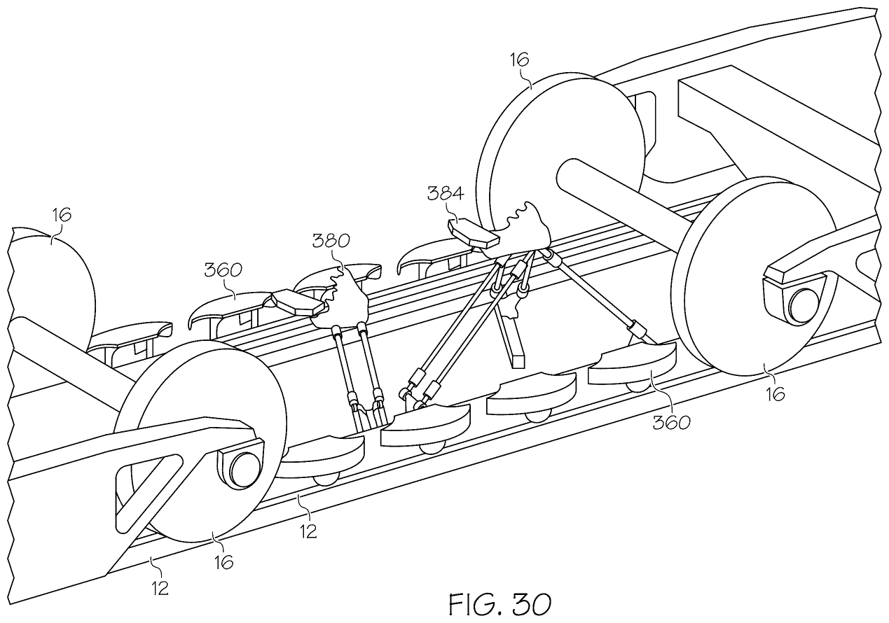

The vehicle may further include one or more than one multisense stereo camera 384. In one embodiment, the vehicle may include one camera mounted at the front and one camera mounted at the rear of the vehicle for navigation clearance sensing, see FIG. 29. In one embodiment, the vehicle may include stereo cameras in the middle of the frame for imaging the underside of railcars, imaging railcar couplings, and/or imaging air valves, see FIG. 30. In one embodiment, additional cameras may be mounted to the manipulators for precision sensing. In one embodiment, the cameras are robust multimodal cameras that can provide 2D and 3D data for navigation and manipulation tasks. In one embodiment, the cameras can validate that there is open or free space for the vehicle and the manipulators to move within.

In one embodiment, the vehicle may include one or more than one LED light attached to the frame. In one embodiment, the vehicle may include one LED light mounted at the front and one mounted at the rear of the vehicle. In various aspect, the LED lighting is electrically synchronized with the cameras attached to the frame.

In one embodiment, the vehicle may include one or more than one status light 387 for indicating the status of the vehicle. For example, when the light is lit in a first color, the vehicle may be in an error state and when the light is lit in a second color, the vehicle may be in an autonomous state.

A suitable control circuit, or controller, may include an integrated circuit, a general purpose computing device, one or more processers, a memory device (e.g., forms of random access memory), a communications device (e.g., a modem, communications switch, or optical-electrical equipment).

In one embodiment, the control circuits, controllers or systems described herein may have a local data collection system deployed and may use machine learning to enable derivation-based learning outcomes. The control circuits may learn from and make decisions on a set of data (including data provided by the various sensors), by making data-driven predictions and adapting according to the set of data. In embodiments, machine learning may involve performing a plurality of machine learning tasks by machine learning systems, such as supervised learning, unsupervised learning, and reinforcement learning. Supervised learning may include presenting a set of example inputs and desired outputs to the machine learning systems. Unsupervised learning may include the learning algorithm structuring its input by methods such as pattern detection and/or feature learning. Reinforcement learning may include the machine learning systems performing in a dynamic environment and then providing feedback about correct and incorrect decisions. In examples, machine learning may include a plurality of other tasks based on an output of the machine learning system. In examples, the tasks may be machine learning problems such as classification, regression, clustering, density estimation, dimensionality reduction, anomaly detection, and the like. In examples, machine learning may include a plurality of mathematical and statistical techniques. In examples, the many types of machine learning algorithms may include decision tree based learning, association rule learning, deep learning, artificial neural networks, genetic learning algorithms, inductive logic programming, support vector machines (SVMs), Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components restricted to being integer-valued. Algorithms and machine learning techniques and systems may be used in computational intelligence systems, computer vision, Natural Language Processing (NLP), recommender systems, reinforcement learning, building graphical models, and the like. In an example, machine learning may be used making determinations, calculations, comparisons and behavior analytics, and the like.

In one embodiment, the control circuit may include a policy engine that may apply one or more policies. These policies may be based at least in part on characteristics of a given item of equipment or environment. With respect to control policies, a neural network can receive input of a number of environmental and task-related parameters. These parameters may include, for example, operational input regarding operating equipment, data from various sensors, location and/or position data, and the like. The neural network can be trained to generate an output based on these inputs, with the output representing an action or sequence of actions that the equipment or system should take to accomplish the goal of the operation. During operation of one embodiment, a determination can occur by processing the inputs through the parameters of the neural network to generate a value at the output node designating that action as the desired action. This action may translate into a signal that causes the vehicle to operate. This may be accomplished via back-propagation, feed forward processes, closed loop feedback, or open loop feedback. Alternatively, rather than using backpropagation, the machine learning system of the control circuit may use evolution strategies techniques to tune various parameters of the artificial neural network. The control circuits may use neural network architectures with functions that may not always be solvable using backpropagation, for example functions that are non-convex. In one embodiment, the neural network has a set of parameters representing weights of its node connections. A number of copies of this network are generated and then different adjustments to the parameters are made, and simulations are done. Once the output from the various models are obtained, they may be evaluated on their performance using a determined success metric. The best model is selected, and the vehicle control circuit executes that plan to achieve the desired input data to mirror the predicted best outcome scenario. Additionally, the success metric may be a combination of the optimized outcomes, which may be weighed relative to each other.

Use of phrases such as “one or more of . . . and,” “one or more of . . . or,” “at least one of . . . and,” and “at least one of . . . or” are meant to encompass including only a single one of the items used in connection with the phrase, at least one of each one of the items used in connection with the phrase, or multiple ones of any or each of the items used in connection with the phrase. For example, “one or more of A, B, and C,” “one or more of A, B, or C,” “at least one of A, B, and C,” and “at least one of A, B, or C” each can mean (1) at least one A, (2) at least one B, (3) at least one C, (4) at least one A and at least one B, (5) at least one A, at least one B, and at least one C, (6) at least one B and at least one C, or (7) at least one A and at least one C.

The singular forms “a”, “an”, and “the” include plural references unless the context clearly dictates otherwise. “Optional” or “optionally” means that the subsequently described event or circumstance may or may not occur, and that the description may include instances where the event occurs and instances where it does not. Approximating language, as used herein throughout the specification and claims, may be applied to modify any quantitative representation that could permissibly vary without resulting in a change in the basic function to which it may be related. Accordingly, a value modified by a term or terms, such as “about,” “substantially,” and “approximately,” may be not to be limited to the precise value specified. In at least some instances, the approximating language may correspond to the precision of an instrument for measuring the value. Here and throughout the specification and claims, range limitations may be combined and/or interchanged, such ranges may be identified and include all the sub-ranges contained therein unless context or language indicates otherwise.

This written description uses examples to disclose the examples, including the best mode, and to enable a person of ordinary skill in the art to practice the examples, including making and using any devices or systems and performing any incorporated methods. The claims define the patentable scope of the disclosure and include other examples that occur to those of ordinary skill in the art. Such other examples are within the scope of the claims if they have structural elements that do not differ from the literal language of the claims, or if they include equivalent structural elements with insubstantial differences from the literal language of the claims.

What is claimed is:

1. A vehicle for use on a railway, the railway having a pair of rails, each of the pair of rails having a resting surface for a wheel of a railcar, the vehicle comprising:
a frame; and
a plurality of articulatable arms extending from the frame, each articulatable arm comprising:
a first joint portion attached to the frame;
a second joint portion rotatably attached to the first joint portion about an articulation axis;
a flanged wheel rotatably attached to the second joint portion such that the flanged wheel is rotatable relative to the second joint portion about a rotation axis;
a drive motor configured to rotate the flanged wheel about the rotation axis; and
an actuator configured to rotate the second joint portion and the flanged wheel relative to the first joint portion about the articulation axis to transition the articulatable arm between a first configuration where the flanged wheel is engaged with and rests upon the resting surface of one of the rails and a second configuration where the flanged wheel is disengaged from the rails, and each articulatable arm, or pairs of arms, of the plurality of articulatable arms is selectively actuatable between the first configuration and the second configuration.

2. The vehicle of claim 1, wherein the first joint portion and the second joint portion are aligned in the first configuration, and wherein the first joint portion and the second joint portion are oriented between thirty and ninety degrees apart in the second configuration.

3. The vehicle of claim 1, wherein the second joint portion is rotatable relative to the first joint portion in an articulation plane, wherein the flange wheel is rotatable in a rotation plane, and wherein the rotation plane is orthogonal to the articulation plane.

4. The vehicle of claim 1, wherein the second joint portion is rotatable relative to the first joint portion toward an articulated orientation where the flanged wheel is higher than the frame.

5. The vehicle of claim 1, wherein the second joint portion is rotatable relative to the first joint portion toward an articulated orientation where the flanged wheel is adjacent to the frame.

6. The vehicle of claim 1, wherein the frame is positioned the same vertical distance relative to the pair of rails when at least one of the articulatable arms is moved between the first configuration and the second configuration.

7. The vehicle of claim 1, wherein each of the flanged wheels are selectively actuatable about their respective rotation axis.

8. The vehicle of claim 1, wherein, in the first configuration, each of the flanged wheels are configured to exert a tractive force onto the resting surface of the rail upon rotation of the flanged wheel about their respective rotation axes.

9. The vehicle of claim 1, wherein, when each of the articulatable arms are transitioned between the first configuration and the second configuration, each of the flanged wheels is configured to be drivingly rotated about their respective rotation axes.

10. The vehicle of claim 1, wherein the frame defines a longitudinal axis, and wherein the articulatable arms are disposed on the frame in an alternating pattern about the longitudinal axis.

11. The vehicle of claim 1, wherein the frame defines a lateral frame width that is less than the distance between the pair of rails of the railway.

12. A vehicle, comprising:
a frame;
drive wheels;
articulatable arms extending from the frame and supporting the drive wheels, the articulatable arms selectively transitionable between first orientations and second orientations, and the drive wheels being engageable with rails that are configured to support a rail vehicle having wheel pairs, in the first orientations the drive wheels engage with the rails to support the frame, and in the second orientations the drive wheels disengage from the rails; and
a control circuit configured to:
receive sensor input indicative of detecting at least one wheel of the wheel pairs on at least one of the rails; and
selectively transition the articulatable arms between the first orientations and the second orientations to avoid contact with the wheel pairs of the rail vehicle while maintaining the frame within a region between the rails.

13. The vehicle of claim 12, wherein the control circuit is configured to selectively transition the articulatable arms between the first orientations and the second orientations while maintaining a minimum number of flanged wheels engaged with the rails.

14. The vehicle of claim 12, wherein the control circuit is configured to sequentially transition the articulatable arms between the first orientations and the second orientations to clear the wheel pairs.

15. The vehicle of claim 12, wherein the control circuit is configured to selectively transition the articulatable arms between the first orientations and the second orientations in a determined pattern.

16. A method, comprising:
detecting a wheel of a transport vehicle that is on a rail being a determined distance from a drive wheel of a second vehicle; and
actuating a support structure of the drive wheel to swing the support structure and drive wheel from a first position to a second position, and the drive wheel in the second position avoids contacting the wheel of the transport vehicle while both traversing the transport vehicle and the second vehicle by each other and maintaining the second vehicle adjacent to the rail.

17. The method of claim 16, further comprising:
detecting that the drive wheel has passed the wheel of the transport vehicle in its direction of travel; and
actuating again the support structure to return the support structure and the drive wheel to the first position and thereby to reengage the rail.

18. The method of claim 16, wherein the support structure pivots about 90 degrees from the first position to the second position.

19. The method of claim 16, wherein the vehicle comprises a frame, and the frame moves downward relative to the rail and the transport vehicle in response to the support structure moving from the first position to the second position.

20. The method of claim 16, wherein the vehicle comprises a frame, and the frame moves upward relative to the rail in response to the support structure moving from the first position to the second position to raise the frame up to traverse an obstacle.
